(19) United States
(12) Patent Application Publication
(10) Pub. No.: US 2010/0216090 A1
(43) Pub. Date: Aug. 26, 2010

(54) LIQUID DROPLET SPRAY CLEANING SYSTEM FOR TEETH WITH TEMPERATURE AND FILTER CONTROLS

(75) Inventors: Garrett Kotlarchik, Seattle, WA (US); Joseph W. Grez, North Bend, WA (US); Paulus Cornelis Duineveld, Drachten (NL); Kristoffer Patrick Kollmer, Seattle, WA (US); Jasper Zuidervaart, Drachten (NL); Martinus Bernardus Stapelbroek, Rolde (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/303,255

(22) PCT Filed: Jun. 25, 2007
(86) PCT No.: PCT/IB07/52453

§ 371 Date: Apr. 7, 2010

Related U.S. Application Data
(60) Provisional application No. 60/817,121, filed on Jun. 27, 2006.

(51) Int. Cl. A61C 17/02

(52) U.S. Cl. 433/32; 433/80

(57) ABSTRACT

The droplet spray teeth cleaning system includes in one aspect a window of temperature and volumetric flow ratio between air and gas for safe and comfortable yet effective operation, the volumetric flow ratio ranging between approximately 24 and 875 and the temperature from approximately 27° C. to a maximum of 60° C. The temperature is maintained by a flow-through heater (74) arranged around a liquid line portion (51) of the droplet spray system, preferably in a handle portion (52) of the system. Also included is a thermocouple heat sensor arrangement (78) which determines the temperature of the liquid prior to the nozzle portion and a control (76, 53) for maintaining the temperature within the temperature/flow ratio window. A filter (126) is provided, preferably in the head portion of the system, for filtering out particles from the liquid, while at the same time permitting adequate flow therethrough at least during the expected lifetime of the replaceable head portion of the system.

This invention relates generally to liquid droplet spray systems for cleaning teeth, and more particularly concerns selected aspects of such a system, including the feature of maintaining the temperature of the liquid within a selected window and the feature of filtering the liquid so as to prevent clogging of the liquid spray nozzle.

Droplet jet cleaning systems for teeth are generally known, and are described in various patents and published patent applications. One such patent application has been published as International Publication No. WO2005070324. That patent application is owned by the assignee of the present invention, the contents of which are hereby incorporated by reference. In that publication, liquid (water) droplets are generated and then accelerated to a desired spray velocity by a stream of gas, such as air.

In other known systems, liquid droplets are generated and then accelerated to high velocities by other means, such as a swirl nozzle. In any case, however, the liquid droplets must have a required combination of size and velocity to produce effective cleaning of the teeth. Many of these systems are embodied in devices which are designed and intended for home use; hence, it is desirable that such devices be capable of heating the liquid to a temperature within a certain window, so that the spray is comfortable in use. This is especially important for those with sensitive teeth. Accordingly, temperature of the liquid droplets as they impact the teeth and/or gums is an important part of the operation of the system.

Relative to heating of the liquid, it is important to have a system to heat the liquid which is efficient and does not consume significant power. Also, it is desirable that the heating system be relatively small and compact. The resulting system should be able to fit into a hand-held device or the hand-held portion of a tethered device.

A further concern with such a droplet spray system is to ensure a continuous, full stream of fluid through the spray nozzle. The openings in the nozzle are typically of such a size that particles in the liquid, whether it be tap water, mouthwash or other liquid, will become trapped in the openings, resulting in a partial or even complete blockage of the openings and hence the nozzle. This will reduce the effectiveness of the droplet spray cleaning system, to the point where it substantially eliminates the spray and the system is as a result inoperative.

Accordingly, one aspect of the invention includes a droplet spray cleaning system for teeth, comprising: a system for generating a stream of liquid from which droplets are generated and then accelerated by a separate stream of gas, the droplets being of such a size and velocity to produce cleaning of the teeth, wherein the stream of fluid has an upper volumetric ratio limit of gas to liquid of approximately 875 and a lower volumetric ratio limit of approximately 24, a lower temperature limit which increases from approximately 27° C. at the lower volumetric ratio limit to approximately 55° C. at the upper volumetric ratio limit, and an upper temperature limit of approximately 45° C. at the lower volumetric ratio limit to 60° C. at a volumetric ratio limit of approximately 250, the upper temperature limit remaining at approximately 60° C. to the upper volumetric ratio limit.

Another aspect of the invention is a system for heating liquid in a droplet spray system for cleaning teeth, comprising: a handle portion with a housing portion for a droplet spray teeth cleaning system which includes a delivery line for liquid and a delivery line for gas; a head assembly portion, including a housing portion therefor, delivery lines in the head for liquid and gas, and a spray nozzle assembly for creating liquid droplets and then accelerating them to produce a spray for cleaning of teeth, wherein the handle or head portion includes a flow-through heating element positioned around the liquid delivery line; and a system for energizing the heating element to heat the liquid in the liquid line to a pre-selected temperature.

Another aspect of the invention is a system for filtering liquid in a droplet spray teeth cleaning system, comprising: a droplet spray system for cleaning teeth comprising a source of liquid and a spray nozzle assembly in which droplets are created and accelerated to a velocity for cleaning of teeth, the droplet spray system including a filter in a liquid line from the source of liquid, located prior to the spray nozzle assembly, the filter having a pore size which is capable of removing particles which would clog a nozzle in the nozzle assembly, and in addition permits a liquid flow rate through the filter sufficient to establish and maintain a droplet spray for a period of time which is approximately at least equal to a pre-established lifetime of a replaceable head portion of the droplet spray system.

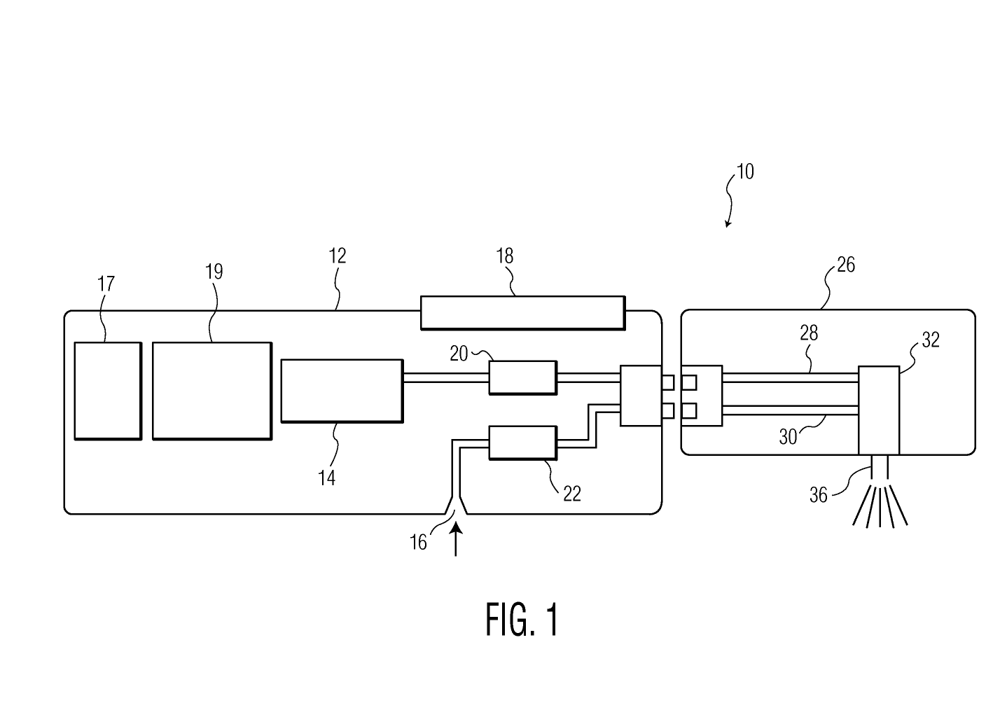

FIG. 1 is a simple schematic diagram of a droplet spray teeth cleaning system.

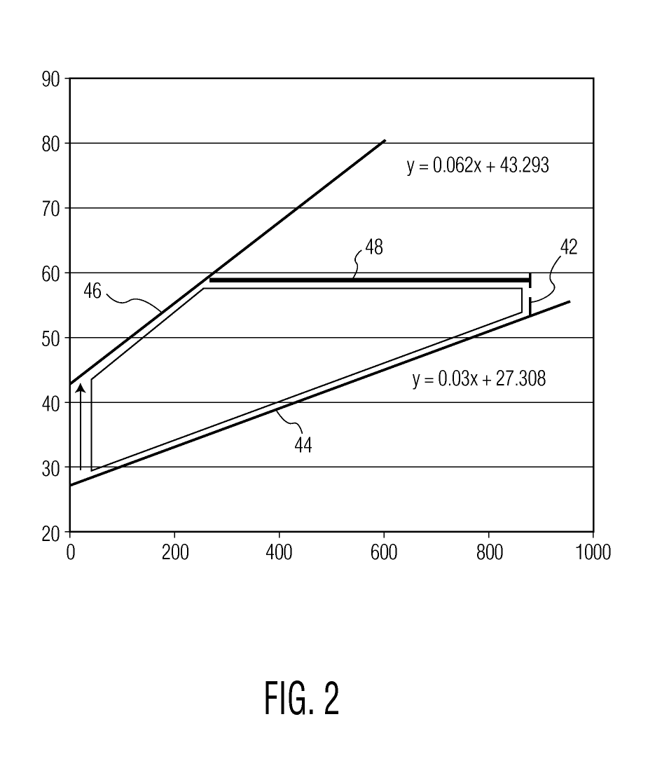

FIG. 2 is a graph showing the operating temperature window for a particular droplet spray fluid teeth cleaning system.

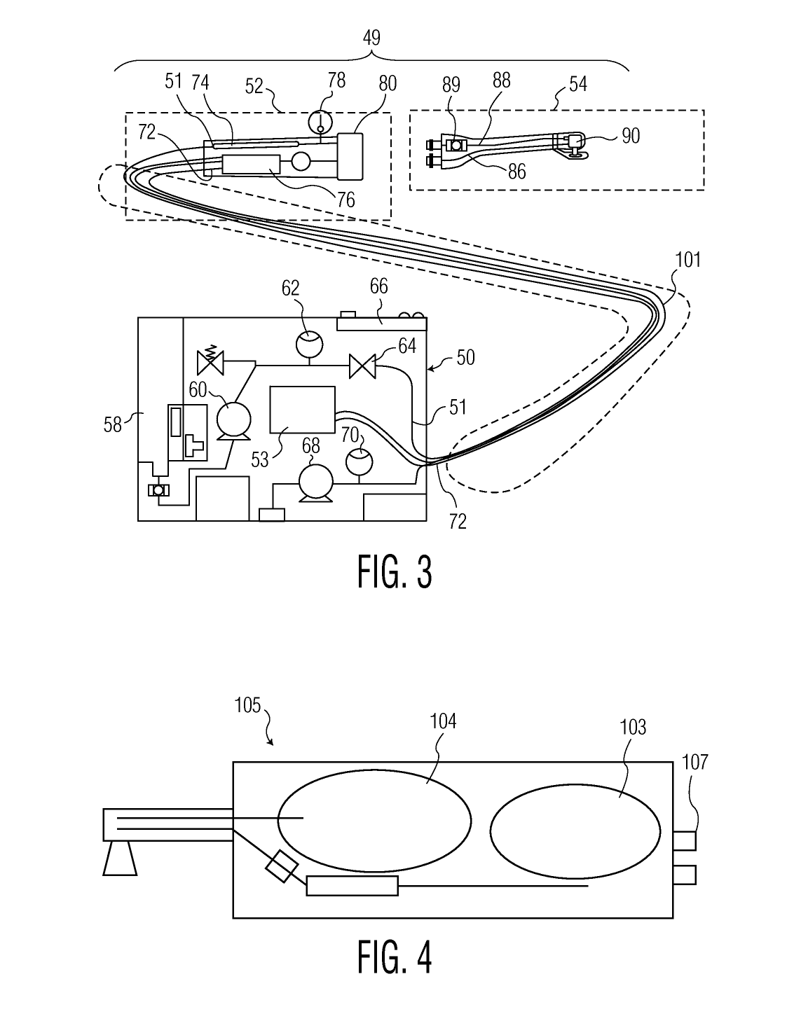

FIG. 3 is a diagram of such a system, including an assembly for heating the liquid spray, in a tethered embodiment.

FIG. 4 is a diagram showing such a system, including an assembly for heating the fluid spray, contained in an integrated, self-contained device.

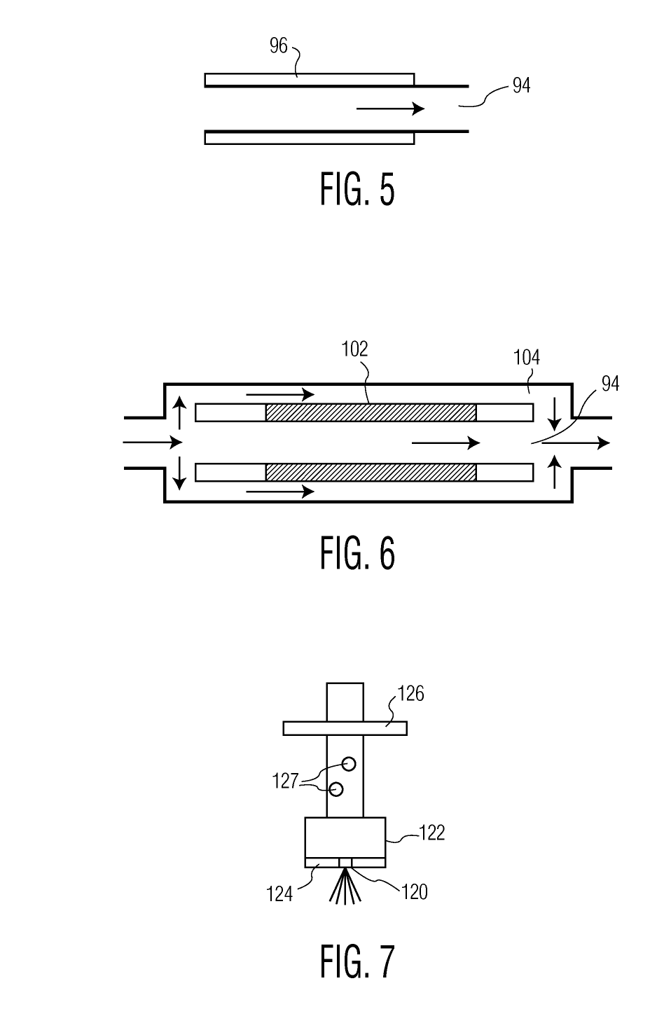

FIG. 5 is a cross-sectional diagram showing the heating arrangement in FIGS. 3 and 4 in more detail.

FIG. 6 is a cross-sectional diagram showing a variation of the system of FIG. 5 including a cooling jacket arrangement.

FIGS. 7-9 show various filter arrangements for a droplet spray system.

FIG. 1 shows in general a diagram of a droplet spray (jet) teeth cleaning system 10. A typical hand-held system for home use will include a handle portion 12 in which is located a source of fluid 14 and in the arrangement shown, an opening 16 for gas from the atmosphere, although the system could include a source of pressurized gas. The handle typically also includes all of the controls for the device 10, including an on/off switch, in a user interface 18.

The handle also contains a power supply 17, such as a battery, and control electronics 19. The liquid and the gas are moved, in the arrangement shown, by pumps 20 and 22 out of the handle into a head portion 26, which includes connecting liquid and gas lines 28 and 30 which in turn connect to a spray assembly 32. In the spray assembly, the stream of liquid is impacted by the stream of gas, which results in the creation of fluid droplets, and then the acceleration of those droplets out through a nozzle 36, which form a spray of droplets of appropriate size and velocity to effectively clean the teeth. In the '324 publication, the droplets are generally 10-15 microns, with an average velocity of approximately 60-70 m/s. However, it should be understood that this is only one example of a liquid droplet spray system. Other means of generating and accelerating liquid droplets of other sizes and to other velocities are contemplated in this invention.

As indicated above, an important aspect of the droplet spray system herein described is the temperature of the liquid spray. It is difficult to measure directly the temperature of the liquid droplets and hence, typically, the temperature of the liquid as it enters the spray assembly 32 is determined. A window of operation has been discovered which includes a range which is effective in cleaning teeth, but also safe for use in the mouth. This window is shown in the graph 36 of FIG. 2. The graph includes the water temperature in degrees Centigrade along the “Y” axis with the volumetric ratio of the flow of gas (air) and liquid (water) along the X axis, in cubic centimeters per minute. The lower limit of effective cleaning relative to the volume ratio, shown to the far left in the graph at line 40 is approximately 24, while the upper volume ratio limit, above which the flow of air becomes too great for complete safety and comfort, is a ratio of approximately 875, at line 42. More specifically, the lower limit relates to how well the droplet spray removes plaque. The lower limit volumetric ratio uses the lowest flow of air that is considered to be the threshold for effective plaque removal (approximately 1200 scc/min) divided by the highest liquid flow for a good spray (50 cc/min). The upper limit, relative to safety and comfort, uses an air flow (upper limit) of 3500 scc/min and a flow of water of 4 cc/min, which is the lowest flow of water that can still produce a symmetrical spray.

The lower temperature boundary for the operating window, shown at line 44, begins at approximately 27°, where it intersects with line 40, to a temperature of approximately 53° C. at its intersection with line 42, in an approximately straight line. The line is defined by the formula:

y=0.03x(ratio)+27.308

The upper temperature boundary of the operating window includes a first portion 46 which defines the upper limit of acceptable temperatures beginning at the left-hand side of the window, from line 40, defined by the formula:

y=0.062x+43.293

This line is operative until a temperature of 60° C. is reached, which forms the second portion 48 of the upper boundary of the operating window. The operating window is thus restricted to a maximum of 60° C.

The graph of FIG. 2 provides an effective window of operation. It includes specific boundaries of temperature versus the ratio of gas/liquid volume flow.

In using temperature and volumetric flow ratio as the variables, the proper area of operation can be determined and controlled in a simple and straightforward way.

In order to operate in the desired window shown in FIG. 2, a reliable heating system for the liquid is necessary. In the present arrangement, the liquid, e.g. water, is heated, as opposed to heating the gas or heating both the gas and the liquid. It is not particularly efficient to heat both the gas and the liquid, and heating the gas alone to heat the liquid requires simply too high of a gas temperature to safely and efficiently produce effective results.

In the embodiment shown, a flow-through heater is used to heat the liquid, the flow-through heater being positioned around the fluid line in the device prior to the spray assembly. A first embodiment of a fluid droplet system with a heating assembly is shown in FIG. 3, in which a flow-through heater is used in a handle portion of a hand-held portion of the droplet spray system. The system in FIG. 3 includes a hand-held portion or unit 49 tethered to a base housing 50, the hand-held portion including a unit handle 52 and a head 54 which is removable from the handle. In the housing 50 is located a source of liquid 58, a pump for the liquid 60, a flow controller 62, and a liquid control valve 64.

The liquid is moved out of housing 50 through a liquid line 51. Housing 50 also includes a user interface 66, with controls to permit the user to operate the device. Air is received from the atmosphere by a pump 68, directed through a flow controller 70 and out through a gas line 72. The liquid line 51 and the gas line 72 are connected to the handle portion 52 of the hand-held unit, the handle including a flow-through heater 74 around liquid line 51, as well as handle electronics 76. Following heater 74 is a temperature sensor 78 which is connected back to the handle electronics 76. The handle also includes a connection interface 80 which connects to a corresponding portion of head 54. Alternatively, the power provided to the flow-through heater structure could be programmed, eliminating the need for a sensor and related control circuits. The head 54 includes a gas line 86 and a liquid line 88 with a filter 89 therein, which lines extend to a spray nozzle assembly 90, which produces the spray of droplets.

FIG. 5 shows a simple cross-section of the flow-through heater 74 in FIG. 3. In one embodiment, a liquid line or tube 94, in the handle portion of the system, has an inside diameter of 1.5 mm and an outside diameter of 3.0 mm. The liquid line is surrounded by 0.75 mm isolated resistance (copper) wire (7.5 Ohms/meter) 96, closely wound around the tube 94, forming the flow-through heater. The heating element is within a range of 3-100 watts. An alternative to copper wire could be a resistor. Referring again to FIG. 3, the thermocouple temperature sensor 78 is positioned in the flow of water through the liquid tube 94 as close to the exit of the flow-through heater 74 as possible. The tethered arrangement of FIG. 3 produces a steady-state liquid temperature within 35 seconds from start-up. The temperature of the liquid will, in the embodiment shown, vary between 54° C. and 67° C. at the end of the flow-through heater.

In the embodiment of FIG. 3, some of the control electronics 76 for the heater is located in the handle 52 with signals in electronics tether line 101 from base 50 (control circuit 53). The copper wire in the flow-through heater is heated by an electric current provided from the base 50.

When the flow-through heater is located in the handle (FIG. 3), a maximum tolerable temperature for the user for the outside of the handle is approximately 40° C. The temperature of the handle would ordinarily increase during use due to heat radiating outwardly from the copper wire heater. This increase in temperature is controlled and kept below the maximum by increasing the thickness of the housing (casing) for the handle or using an air gap between the flow-through heater element 74 and the housing. In addition, the outside of the flow-through heater element can be cooled by a water flow exchanger, such as shown in FIG. 6. The heater element is shown at 102. Surrounding the heater element is a jacket assembly 104. Liquid is delivered between heater element 102 and jacket 104, cooling the exterior of the heater element 102 and hence maintaining the handle housing (FIG. 3) at a desired, comfortable temperature for the user.

FIG. 4 shows an assembly 105 where the heater element/control is contained within the handle, as well as the source of liquid 103, the source of gas 104, the heater element and the control circuits (not shown). The heated liquid and the gas are then provided through separate lines to a replaceable head portion. This arrangement makes the hand-held unit self-contained and is hence easier to use, but requires careful design and arrangement of parts. The hand-held embodiment could be powered by a battery, although 25 watts of power is required, which is more than a typical battery can reasonably provide. A power cord can also be used to connect a wall outlet to the device at 107.

It is also possible, in either of the embodiments of FIGS. 3 and 4, to position the flow-through heater in the head portion. This has the advantage that it is positioned closer to the spray nozzle, and thus less heat loss is incurred between the heater element and the nozzle than in the handle arrangement of FIG. 3. This results in a faster response/steady state time. Such an embodiment requires that all the control electronics also be in the head portion, which makes the head portion more complicated and also more expensive to replace.

It should be understood that various arrangements can be made to reduce the response time of the heating system. For instance, it is possible to use a smaller internal diameter tubing line between the heater element and the spray nozzle. The thickness of the tubing line wall can also be decreased, or a different material used, with a larger thermal diffusion coefficient, such as for instance, a metal. The size of the filter can also be reduced. It should be understood that the temperature of the liquid measured in the device itself will be greater than the temperature of the liquid as it impacts the teeth, due to the cooling effect of the impinging gas (air) flow as it produces and then accelerates the liquid droplets.

In one operating example, with a spray diameter of 2.4 mm, it is known that for typical liquid and gas flow rates, above 8 ml per minute, the liquid temperature (temperature of the droplets) just before it impacts the substrate, for purposes of comfort, should be at most 1° C. larger than the substrate temperature (the temperature of the teeth). There will be some cooling of the liquid as it travels between the spray assembly and the teeth. Again, in one specific example, for a liquid droplet radius in the spray of 6 μm with a droplet velocity of 65 meters per second, the drop in temperature of the droplets as they travel through the air is approximately 4°. To have a liquid spray temperature of 40° C., as it impacts the teeth, the liquid temperature should preferably be approximately 45° when it leaves the spray nozzle.

Filtering of the liquid is also usually important for proper operation of the droplet jet system. Referring to FIG. 7, as indicated above, with an opening 120 in the spray nozzle 122 of desired size, in the range of 10-150 μm, clogging of the opening 120 and reduction of the droplet spray will occur. Partial or complete blocking of the nozzle opening is a serious problem, as it affects the quality of the spray and also decreases the number of droplets exiting the nozzle, decreasing the cleaning rate.

Partial blocking of the nozzle opening 120 can occur due to small impurities present in the liquid. These impurities are transported with the liquid to the opening 120 of the nozzle plate 124, resulting in partial blocking of the opening. When the nozzle opening 120 is fully blocked, this stops completely the flow of liquid in the system.

In the embodiment shown, a filter 126 is positioned just before the spray nozzle 122. The pore size of the filter 126 is smaller than the diameter of the nozzle opening 120. Particles in the fluid will be collected in the filter 126 and thus will be prevented from reaching the nozzle opening. The pore size of the filter, however, must not be too small, as this will increase the resistance of the filter to the flow of liquid therethrough, which in turn results in a significant decrease in the velocity with which the droplets leave the spray nozzle.

In the arrangement shown, a useful range in pore size will be from 0.05 μm to 50 μm, with a preferred range of 1 μm to 5 μm. In this arrangement, effective filtering of particles does occur, but does not appreciably affect the flow rate of liquid through the filter over the normal expected lifetime of the head portion, which is typically six months. Hence, during the typical lifetime of a replaceable head portion, filter 126 filters out the particles in the liquid without decreasing the flow rate through the filter, i.e. the pressure drop remains approximately the same across the filter over this time period.

It is usually desirable that the filter be hydrophilic material, which is useful with various kinds of fluid, including tap water, as well as mouthwashes. Various available glass fiber filters can also be used successfully with both tap water and mouthwash.

In some situations involving a droplet spray system, bubbles are formed within the fluid prior to the nozzle, as illustrated at 127 in FIG. 7. The bubbles cannot escape because the filter will in fact block them from moving back upstream. Bubbles are harmful to the effective operation of the system, as they disturb the liquid flow through the spray assembly and hence will have a negative effect on the resulting droplets. Bubbles are created within the liquid when fluid is removed from the system, but small volumes of liquid remain in the filter, enclosing air. The air forms a gas bubble when liquid is again passed through the filter.

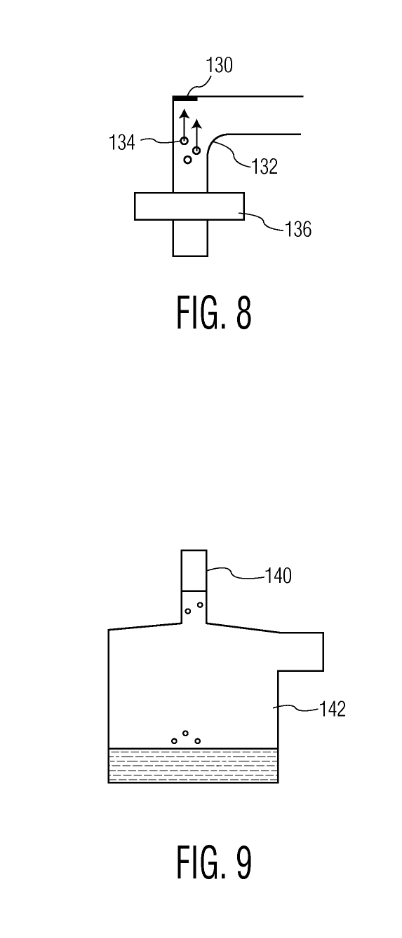

One possible solution to the bubbles is to let the bubbles escape, such as shown in the embodiment of FIG. 8 where an air escape member 130 in the liquid tubing 132 is shown. The tubing 132 is designed in such a way that the velocity of the liquid through the tubing is smaller than the typical velocity of the bubbles 134. Hence, in operation of the system, the bubbles will rise to the corner of the tubing and remain there. The bubbles, but not the liquid, pass through the filter member 136, which has a small pore size, typically on the order of 0.02 μm.

FIG. 9 shows another arrangement to remove air bubbles from the liquid, where a section of tubing 140 is added to the liquid delivery system 142 which contains a small volume of air. During operation, the bubbles generated will rise to the added tube section 140 and coalesce with the air enclosed in it. The added tube section 140 is designed so that it will not completely fill, either due to capillary rise or the pressure on the water. This can be accomplished by making the tube 140 much longer than its width. The shape of the added tube 140 and the nozzle can be altered from that shown to ensure that bubbles are captured within the tube arrangement.

A fluid droplet system has thus been described which has a particular structure, including control features, to maintain an effective and comfortable temperature/fluid volume operating window. Further, the system includes a filter arrangement which prevents clogging of the nozzle opening while maintaining adequate liquid flow therethrough.

Although a preferred embodiment of the invention has been disclosed for purposes of illustration, it should be understood that various changes, modifications and substitutions may be incorporated in the embodiment without departing from the spirit of the invention which is defined by the claims which follow.

1. A droplet spray cleaning system for teeth, comprising:
a system for generating a stream of liquid from which droplets are generated and then accelerated by a separate stream of gas, the droplets being of such a size and velocity to produce cleaning of the teeth, wherein the stream of fluid has an upper volumetric ratio limit (42) of gas to liquid of approximately 875 and a lower volumetric ratio limit (40) of approximately 24, a lower temperature limit (44) which increases from approximately 27° C. at the lower volumetric ratio limit to approximately 55° C. at the upper volumetric ratio limit, and an upper temperature limit (46, 48) of approximately 45° C. at the lower volumetric ratio limit to 60° C. at a volumetric ratio of approximately 250, the upper temperature limit remaining at approximately 60° C. to the upper volumetric ratio limit.

2. A system for heating liquid in a droplet spray system for cleaning teeth, comprising:
a handle portion (52) with a housing portion for a droplet spray teeth cleaning system which includes a delivery line for liquid (51) and a delivery line for gas (72);
a head assembly portion (54), including a housing portion therefor, delivery lines (88, 86) in the head for liquid and gas, and a spray nozzle assembly (90) for creating liquid droplets and then accelerating them to produce a spray for cleaning of teeth, wherein the handle or head portion includes a flow-through heating member (74) positioned around the liquid delivery line; and
a system for energizing the heater member to heat the liquid in the liquid line to a pre-selected temperature.

3. The system of claim 2, including a sensor (78) for the temperature of the liquid and a control circuit (76, 53) for controlling the operation of the flow-through heater to maintain the liquid within a selected temperature range.

4. The system of claim 2, wherein the heating member is located in the handle portion of the droplet spray assembly.

5. The system of claim 2, wherein the heating member is located in the head portion of the system.

6. The system of claim 2, wherein the head portion is removable from the handle portion.

7. The system of claim 2, wherein the head and handle portions comprise an integral assembly.

8. The system of claim 2, wherein the heating member comprises a resistance wire wound around the liquid line for a selected distance and wherein the heating element is within a range of 3 to 100 watts.

9. The system of claim 2 including a jacket member (104) surrounding the flow-through heater element for receiving and directing cooling liquid therethrough, thereby reducing heat transmitted to the housing of the handle.

10. A system for filtering liquid in a droplet spray teeth cleaning system, comprising:
a droplet spray system for cleaning teeth comprising a source of liquid and a spray nozzle assembly in which droplets are created and accelerated to a velocity for cleaning of teeth, the droplet spray system including a filter (126) in a liquid line from the source of liquid, located prior to the spray nozzle assembly (122), the filter having a pore size which is capable of removing particles which would clog a nozzle opening in the nozzle assembly, and in addition permits a liquid flow rate through the filter sufficient to establish and maintain a droplet spray for a period of time which is approximately at least equal to a pre-established lifetime of a replaceable head portion of the droplet spray system.

11. The filter of claim 10, wherein the pore size is in the range of 0.05 μm to 50 μm.

12. The system of claim 11, wherein the pore size is in the range of 1 μm to 5 μm.

13. The system of claim 10, wherein the filter comprises a hydrophilic material.
